(19) United States
(12) Patent Application Publication
(10) Pub. No.: US 2023/0152667 A1
(43) Pub. Date: May 18, 2023

(54) PHOTONIC TENSOR CORE MATRIX VECTOR MULTIPLIER

(71) Applicant: The George Washington University, Washington, DC (US)

(72) Inventors: Mario MISCUGLIO, Arlington, VA (US); Volker J. SORGER, Alexandria, VA (US)

(21) Appl. No.: 17/919,456

(22) PCT Filed: Apr. 16, 2020
(86) PCT No.: PCT/US2020/028516

§ 371 Date: Oct. 17, 2022

(51) Int. Cl. G02F 3/00; G06E 3/00

(52) U.S. Cl. CPC G02F 3/00; G06E 3/005; G06E 3/008

(57) ABSTRACT

A system performing optical and/or electro-optical tensor operations and featuring a photonic dot product engine with a first input and a second input and summation to perform multiply-accumulate operations. The first and/or second input is a matrix, and/or a vector, and/or scalar. The system is a Photonic Tensor Core.

### BACKGROUND OF THE INVENTION

### Field of the Invention

The present invention relates to a tensor processor performing matrix multiplication.

### Background of the Related Art

For a general-purpose processor offering high computational flexibility, matrix operations take place serially, one-at-a-time, while requiring continuous access to the cache memory, thus generating the so called “von Neumann bottleneck”. Specialized architectures for neural networks (NN) such as Graphic Process Units (GPUs) and Tensor Process Units (TPUs), have been engineered to reduce the effect of the von Neumann bottleneck enabling cutting-edge machine learning models. The paradigm of these architectures is to offer domain-specificity such as being optimized for performing convolutions or Matrix Vector Multiplications (MVMs) operations, unlike CPUs, in parallel deploying for instance via systolic algorithms.

GPUs have thousands of processing cores optimized for matrix math operations, providing tens to hundreds of T FLOPS (Floating point operations) of performance which makes GPUs the obvious computing platform for deep (i.e. multi-layered) NN-based artificial intelligence (AI) such as machine-learning (ML) applications. GPUs and TPUs are particularly beneficial with respect to CPUs, but when used to implement deep NN performing inference on large 2-dimensional data sets such as images, they are rather power-hungry and require long computation time (>tens of ms). Moreover, smaller matrix multiplication for less complex inference tasks (e.g. MIST, CIFAR-10 datasets) are still challenged by a non-negligible latency predominantly due to the access overhead of the various memory hierarchies and the latency in executing each instruction in the GPU.

Given this context of computational hardware for obtaining architectures that mimic efficiently some functionality of the biological circuitry of the brain, it is necessary to explore and reinvent the operational paradigms of current logic computing platforms when performing matrix algebra, by replacing sequential and temporized operations, and their associated continuous access to memory, with massively parallelized distributed analog dynamical units, towards delivering efficient post-CMOS devices and systems summarized as non von Neumann architectures. In this paradigm shift the wave nature of light and related inherent operations, such as interference and diffraction, can play a major role in enhancing computational throughput and concurrently reducing the power consumption of neuromorphic platforms.

In recent years, the revolutionizing impact of NNs contributed to the development of a plethora of emerging technologies, ranging from free space diffractive optics to nanophotonic processors aiming to improve the computational efficiency of specific tasks performed by NN. Integrated photonic platforms can indeed provide parallel, power-efficient and low-latency computing, which is possible because analog wave chips can a) perform the dot product inherently using light matter interactions such as via a phase shifter or modulator, b) enable signal accumulation (summation) by either electromagnetic coherent interference or incoherent accumulation through detectors, and c) enable parallelism strategies and higher throughput using multiplexing schemes such as wavelength- or polarization division multiplexing, for example.

### SUMMARY OF THE INVENTION

A system comprising of an engine receiving an input(s) and configured to conduct optical and/or electro-optical tensor operations of the input(s) (one or more physical inputs) by means of performing optical or electro-optical, or all-optical dot-product multiplications, and, either coherent or incoherent summation, thus performing multiply-accumulate (MAC) operations. The entire photonic tensor core (PTC) processor is comprised of modular PTC sub-modules, which perform said multiply-accumulate (MAC) operations.

The PTC sub-modules comprise of a photonic dot product engine (PDPE) having (an) first input(s) and (a) second input(s). The first and/or second input is a matrix, or a vector, or a scalar. The PTC and PDPE have integrated photonics, and/or fiber optics, and/or optical free-space, and/or a combination of these that optically performs the dot-product multiplication of the first input and the second input. A plurality of PTC sub-modules form a Photonic Tensor Core (PTC) processor unit.

### BRIEF DESCRIPTION OF THE FIGURES

FIG. 1 is a block diagram of an exemplary layout of the photonic tensor core (PTC) sub-module and dot product engine including inputs and outputs. Note, the DACs are optional;

FIG. 2(a) is a schematic layout one single photonic dot-product engine (PDPE);

FIG. 2(b) shows possible dot product implementation options claimed herein;

FIG. 3(a) is an exemplary block diagram of the dot product photonic engine using photonic memories (Case 2,i,a,A). Details about these definitions are provided in subsequent figures and the patent description. In brief, the four Case descriptors (e.g. Case 2,i,a,A) relate to (in order of position): input data type, dot product implementation mechanism, summation and amplification options, single- or multi-arm fanout;

FIG. 3(b) is a block diagram of the dot product photonic engine which uses electro-optic tunable structures (Case 1,v,d,B) such as spectrally reconfigurable elements (hence mathematical signal multiplication), which relate to (in order of position): input data type, dot product implementation mechanism, summation and amplification option, single- or multi-arm fanout;

FIG. 4 is a block diagram of the summation options for the accumulation in MAC operation at the output of the dot product engine; where the coherent summation option (Case e) can also include an optical amplifier;

FIG. 5 is an exemplary 4×4 photonic tensor core; and

FIG. 6 tensor core unit conceptual processor used to multiply and accumulate 4×4 (Convolution Neural Network), exemplary stating the photonic memory option for of the PDPE.

### DETAILED DESCRIPTION OF THE INVENTION

In describing the illustrative, non-limiting embodiments of the invention illustrated in the drawings, specific terminology will be resorted for the sake of clarity. However, the invention is not intended to be limited to the specific terms so selected, and it is to be understood that each specific term includes all technical equivalents that operate in similar manner to accomplish a similar purpose. Several embodiments of the invention are described for illustrative purposes, it being understood that the invention may be embodied in other forms not specifically shown in the drawings.

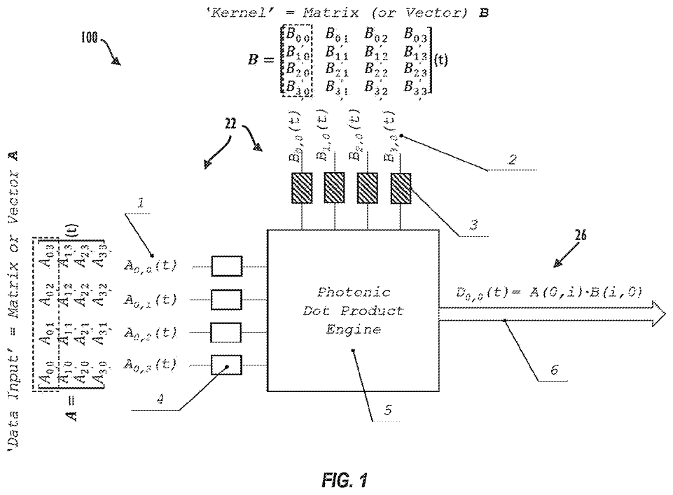

Turning to the drawings, FIG. 1 shows a Tensor Assembly (100) having a Tensor Sub-Unit, which in the example embodiment shown can be a photonic dot-product engine (PDPE) (5) in accordance with a non-limiting example embodiment of the present disclosure. The PDPE (5) receives a first input A (1) and a second input B (2). The first input (1) and the second input (2) can each be a matrix, or a vector, or a scalar in any combination. The PDPE (5) is configured to conduct an optical and/or electro-optical tensor operation of the first and second input (1, 2). The PDPE (5) can perform any number of operations on the input, including the operations shown in Table 1. As shown in that table, the operations include multiplication between two matrixes and/or vectors, and/or scalars, and/or any whichever combinations thereof, as to provide a multiplication output (6). Exemplary, for a matrix/vector case, namely, between the i^{th} row of the input matrix/vector A (1) and the j^{th} column of the kernel B (2).

TABLE 1

| Operation | Dimension | Utilization |
|---|---|---|
| Matrix-Matrix | M₁: N × N | 1 PTC |
| Multiplication | M₂: N × N | |
| Matrix-Vector | M₁: N × N | N PDPEs |
| Multiplication | V₁: N × 1 | |
| Scalar Product | V₁: N × 1 | 1 PDPE |
| | V₂: 1 × N | |
| Pointwise multiplication | M₁: N × N | N PDPEs Without |
| between matrices | M₂: N × N | summation |
| 1-Dimensional | V₁: N × 1 | N² PDPEs |
| Convolution | V₂: N × 1 | |
| (Decompose as Matrix- | | |
| vector Multiplication) | | |
| 2-Dimensional | M₁: N × N | N PDPEs if Input |
| Convolution | M₂: N × N | Fourier Transformed |
| | Striding step 1 | |
| Product for a scalar | V₁: 1 × 1 | N PDPEs Without |
| | M₁: N × N | summation |

In Table 1, V and M stand for Vector and Matrix. In the example embodiment shown in the figures, we consider the dot product engine (100) having 4 reconfigurable inputs (2) and optional (3) and 4 inputs (1) and optional (4). Each dot product engine (4 input (1) and 4 reconfigurable elements (1)) performs 4 multiplications and using the post-multiplication accumulations (40) and (26). Different tensor operations can be decomposed into multiplications and additions which, according to the algorithm complexity (function of the dimension of the matrices) require corresponding utilization.

The first input A (1) are optical signals that are either modulated (i.e. carrying encoded data, termed herein Case 2), or are un-modulated photons arriving (herein termed Case 1), that is, impeding the input ports of A. For the latter, this can be, as an example, be a grating coupler of a photonic integrated circuit (PIC), or a fiber optic system, or a free-space implementation using display light processing (DLP) technology such as a spatial light modulator (SLM), or a digital-mirror-display (DMD) for example.

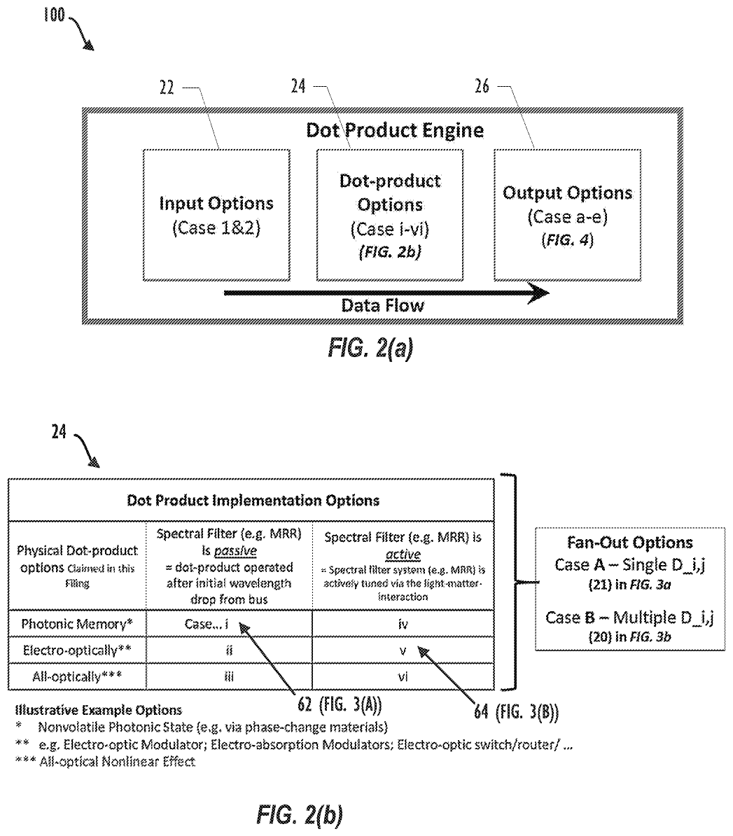

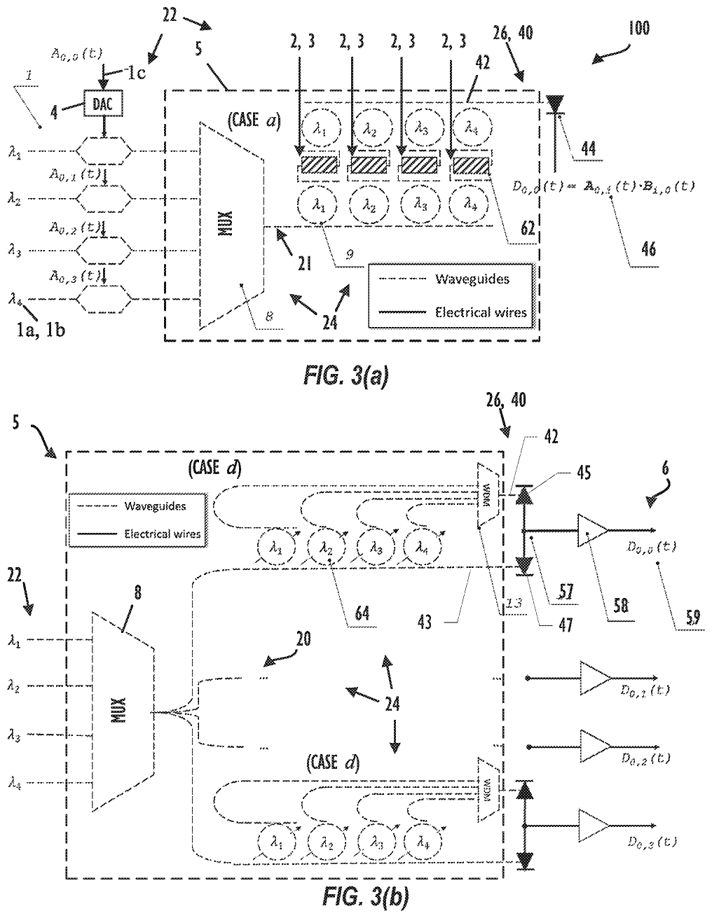

As further shown, the Tensor Assembly (100) can, optionally, include one or more Digital-to-Analog Converters (DAC) (4), (3) at each of the first and second inputs, respectively. The input time variant signals (input matrix A) can be electrical data (Case 1), and/or Optical data (Case 2). The electrical data entering (1) and the kernel input (2) can either be analog and/or digital. Referring momentarily to FIG. 3(a), one example is shown where a phase-change-material or other suitable component, has a first input that receives optical input (1a) and analog electrical input (1b). Digital electrical input (1c) is received at a DAC (4), which converts the digital data (1c) to analog data, which is then received at a second input to the EOM. The EOM combines the first and second input 1(a), 1(b), 1(c) in the optical domain, which then forms the input to the PDPE (5). A similar configuration of the DACs (3) can be provided for the kernel input data B (2), which can also comprise optical data, analog data and/or digital data. The kernel data B (2) and the dot product (5) can be obtained via a multitude (six in one embodiment) options performing the physical dot product multiplication (Cases i-vi). These cases depend on the physical mechanics performing the optical multiplication (Cases i-vi), and on whether active re-modification of the spectral filters is used (Case iv-vi) or not used (Case i-iii), see FIG. 2(b).

To provide some illustrative examples; Cases i & iv rely on photonic nonvolatile memories such those provided by phase-change materials or a nearby electrical capacitor or similar. For this exemplary Photonic Memory-based option, depending on whether the spectral filter is actively tuned to perform the dot-product or just passive (with the dot-product performed post-filter) separates Case i from Case iv, for example.

The spectral filter can be any-type of frequency filters, such as tunable microring resonators, for example. Refer to FIG. 2(b) for more options. DACs (3) and (B) maybe be used as required.

Physically the PDPE takes a signal (A) and amplitude-weights it based on a value B. For example, if data A is a number and B a number between 0-1, then the ‘weighting’ i.e. dot-product=A-value times B. This is one multiplication, and there are N performed per D_{i,j} PTC sub-module.

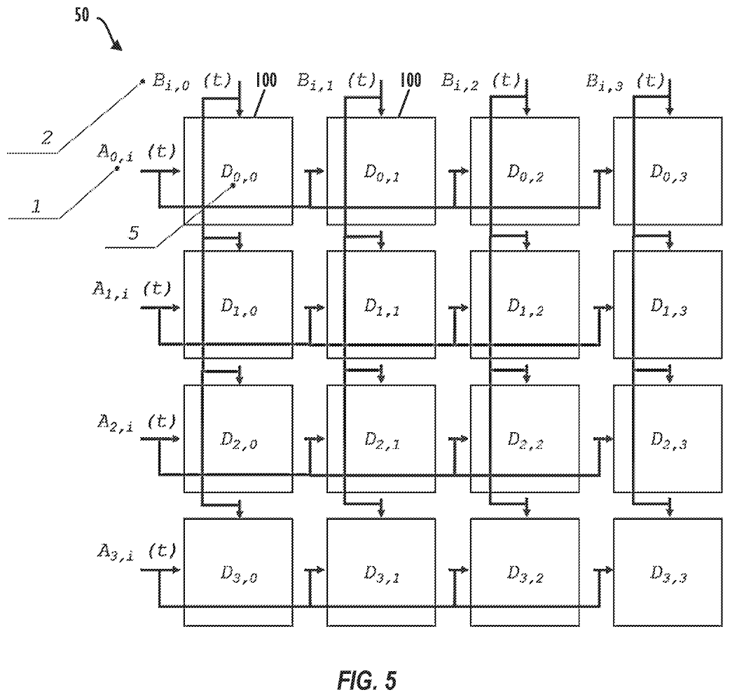

Thus, the PDPE (5) can perform matrix-matrix, matrix-vector, or vector-matrix multiplication. That is, the entire a tensor-core processor (50) (FIG. 5) performs multiplications of N\hat{ }2 vectors, or N\hat{ }2 matrices. Depending on the system layout this occurs at a runtime complexity of O(1), i.e. non-iterative for higher component overhead O(2N\hat{ }3), or O(N) if component overhead is saved O(2N\hat{ }2), thus trading in runtime complexity vs. system complexity.

In either case, the photonic PDPE performs these multiplications more synergistically than electronic counterparts, because of the inherent parallelism such as given by multiplexing options. That is without integrations, meaning that all multiplications happen at the same time with short runtime at similar power consumption to electronics.

Thus, FIGS. 2(a), 2(b) illustrate the options available for configuring the PDPE (5), availing light-matter interaction, including both passive or active filtering. FIG. 2(a) shows one single photonic dot-product engine (PDPE) (5). Once arrayed, say N×N of these, this creates the entire PTC (50) (FIG. 5). The PDPE (5) has input options (Cases 1, 2) (22), dot-product options (Cases i-vi) (24), and output options (Cases a-e) (26). There are a total of 120 possible options: (Cases 1, 2)×(Cases i-vi)×(Cases a-e)×(Case A,B)=2×6×5×2. Referring to FIG. 1, the data input options (22) permit the PDPE (5) to receive optical data which does not require any DACs (Case 1), and electrical data, including both analog data and digital data (which should be converted by the DAC (4) to an analog signal) (Case 2).

The dot-product options (24) refer to the various configurations of the PDPE (5) itself, which are set forth in FIG. 2(b). In FIG. 2(b), Illustrative Example options for performing the dot-product multiplication include: nonvolatile photonic state (e.g. via phase-change materials) or photonic/optical memory functionality (Cases i, iv); electro-optic Modulator or electro-absorption modulators or electro-optic switch/router (Cases ii, v); all-optical nonlinear effects (Cases iii, vi). Note, Cases ii, v can be based on any suitable modulator, such as for example shown in U.S. Patent Publication No. 2020/0057350 for Transparent Conducting Oxide (TCO) Based Integrated Modulators, U.S. Pat. No. 10,318,680 for Reconfigurable Optical Computer, and U.S. Publication No. 2018/0246350 for Graphene-Based Plasmonic Slot Electro-Optical Modulator, all of which are incorporated herein by reference in their entirety. 2) the Graphene modulator.

As shown, each Dot Product implementation has twelve (2×6) implementation options all detailed in FIG. 2(b). Exemplary details are given in FIG. 3; these include implementations when the spectral filters are used actively (e.g., FIG. 3(b), filters (64)) or passively (e.g., FIG. 3(a), receiving input at (62)), and/or, whether the output from the MUX (8) is a single output (Case A), or, fanned-out (Case B). In the fanned out option, as illustrated by element (20) (FIG. 3(b)), multiple D_{i,j}'s (e.g. a row or a column of the PTC) are computed with the same architecture. Illustrative examples for Case A is shown in FIG. 3(a) and for Case B shown in FIG. 3(b). The difference between the passive (Cases i-iii) vs. active (Cases iv-vi) PDPE implementation bears a design choice option of the spectral (wavelength) selection or spectral filters. For instance, FIGS. 3(a), 3(b) show the spectral filters (9) can be microring resonators (MRR) to perform this function, however other options are perceivable as well, such as wavelength selective splitters, or inverse-design based components, for example.

For component scaling, Cases i-iii, the #DACs=2N³ (Case 2) and N² (Case 1), the spectral filter (e.g. MRRs) the number of components scales with 2N³, but note that all spectral filters are ‘passive’ or minimal (e.g. coarse WDM) spectral tuning; for Cases iv & vi, the #DACs=# spectral filters (e.g. MRRs)=2N² (Case 2) and N² (Case 1), but note that for the spectral filter sensitive ‘active’ N-bit turning is required.

The Runtime Latency scales as follows: Case i-iii and Case 1: Σ{TOF+Rx}; Case 2: Σ{TOF+A-DAC+A-RC+Rx}, if the kernel reconfiguration is required, then add Σ{B−DAC+B-RC. Definitions: TOF=time-of-flight, Rx=receiver, AB-RC=RC-delay time from A/B-inputs. For Runtime Latency, Σ{TOF+MRR-RC+MRR-DAC Rx}, if kernel reconfiguration is required, then Σ{TOF+B-DAC+B-RC+Rx}; and for Cases iv-vi, Case 1, Nx{Σ{TOF+Rx+(N−1)×{MRR-RC+MRR-DAC}}}, where MRR-RC is the latency from the tunable spectral filters, such as MRRs, and MRR-DAC the DAC latency for tuning. For Cases iv-vi, Case 2, Nx{Σ{TOF+Rx+MRR-RC+MRR-DAC}}.

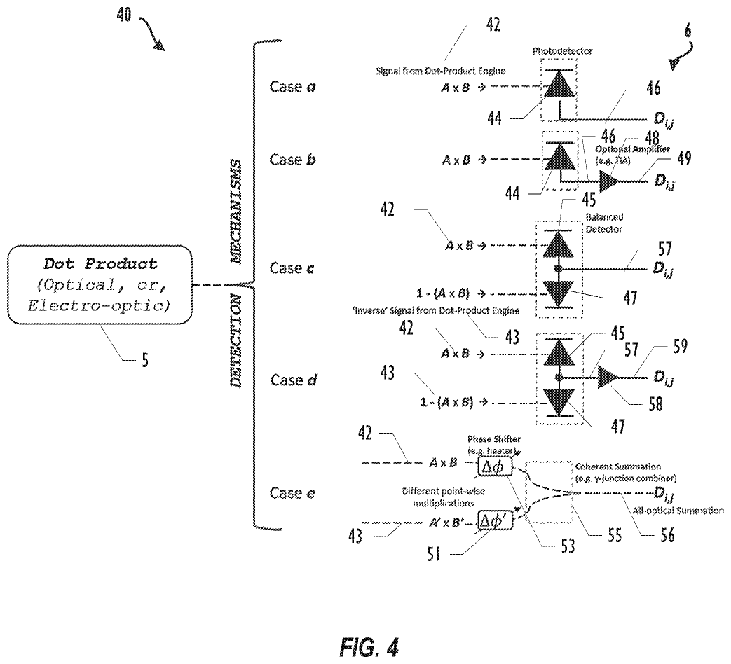

Referring to FIG. 2(a), the output options (26) refer to the configuration of the PDPE (5) at the output end or backend (40) of the Tensor Assembly (100), as also shown in FIGS. 1, 3(a), 3(b). FIG. 4 shows various Backend-Options at the output of the Tensor Assembly (100) and at the output of the PDPE (5), including a single detector (44) without and with an amplifier (48) (Cases a, b), and balanced detectors (45), (47) without and with an amplifier (58) (Cases c, d).

Each Tensor Assembly (100) has an output (6) termed D. This output (6) is either an optical signal, or an electrical. After the dot-product multiplication the results is in the optical domain. The summation can be performed in two conceptually-different ways, either coherently optically (Case z) or electrically using a single photodetector (Cases a, b), or electrically using a combination of photodetectors (i.e. balanced detectors) (Cases c, d). For example, FIG. 4 shows that there are 5 options to convert an optical signal to an electrical signal for summation of weighted products, namely Cases a, b, c, d, e. The photodetectors (44), (45), (47) in the backend (40) can be a single detector (44), or a balanced, i.e. dual detector (45, 47), as shown in Cases a, b, c, d, e.

Referring to FIGS. 2(b), 3, the i^{th} row of the input matrix/vector is given by spectrally distinct signals (7) (e.g. Wavelength Division Multiplexed (WDM)), which, if not already in the optical domain, are modulated by high-speed (e.g. Mach Zehnder) modulators (4) where DACs may be deployed and successively combined by a MUX (e.g. using WDM) (8). The j^{th} column of the kernel matrix is loaded in the B kernel by properly setting its weight states.

FIG. 3(a) shows an exemplary case for the Photonic Assembly (100) having a dot product photonic engine (5) using photonic memories (Case i, a), and illustrates an electrical input 1(c), which can be either analog or, if digital uses an DAC (4). Exemplary, FIG. 3(a) showing dot product Case i. Exemplary, Case iii would have a similar configuration as the photonic memory shown, with the amendment that an all-optical configuration can include a laser line entering the dot product operand (62) to increase the pump density.

The combined input for all the wavelengths is received at a multiplexer (MUX) (8), which combines the first input signals for all the wavelengths into a single first signal and placed on a common input bus. Note, if desired, this could also be omitted, and signal could be multiplied with B (2) without multiplexing. Turning back to FIG. 3(b), one or more spectral filters (9) receive the wavelength combines the first signal from the input bus and drops (e.g., filter out) a single wavelength. The second kernel input (2) is also prepared in a similar manner, namely any digital data is processed by the DAC (3) or analog data without the DAC, and then combined with any of the optical data and/or analog data, for each wavelength. Each filtered first input signal from the spectral filter (9) is then multiplied (dot product) with the second kernel input (2) according to wavelength. The PDPE (5) of FIG. 3(a) is passive since the dot product operation is conducted after the wavelength is dropped from the bus, and electrical input (power) is not needed to perform this operation, once the kernel (2) is written into the system e.g. memory. For the active part, one uses the tunable spectral filter directly to change the amplitude of the dropped signal (64), hence ‘active’ spectral filter (e.g. MRR) tuning.

The multiplied output from each wavelength are combined to form a combined optical signal (42) across all the wavelengths. That combined optical signal (42) is received by a photodetector (44), which sums the optical data across all wavelengths and converts it to a digital signal output (46), D_{0,0}(t)=A_{0,i}(t)·B_{i,0}(t). That output (46) forms the output (6) (FIG. 1) for the PDPE (5) and for the Photonic Assembly (100).

FIG. 4 shows a variety of output options (26) for the backend (40) of the Photonic Assembly (100). FIG. 3(a) shows Case a, having a single combined wavelength signal (42) from the dot product operation (62), a single photodetector (44) and no amplifier. However, any of the output options (26) of FIG. 4 can be utilized for the backend (40) of the Tensor Assembly (100) of FIG. 3(a). Thus, for example, an amplifier (48) can be provided at the output of the photodetector (44) to amplify the output digital signal (46) to provide an amplified output (49), Case b. Or, a balanced detector (Case c & d) can be provided with dual detectors that receive input as in FIG. 3(b).

FIG. 3(b) shows another exemplary case for a Tensor Assembly (100) having a dot product photonic engine (5). This embodiment uses electro-optic kernels (Case 1, v, d, B).

The PDPE (5) of FIG. 3(b) has a balanced detector formed by a first photodetector (45) connected with a second photodetector (47). The first photodetector (45) receives the dot product (A×B) from the WDM, and the second photodetector (47) receives the combined input (43) from the input bus, which represents 1−(A×B) for the active case (Case B). The balanced detector determines the difference between those two inputs (42), (43), and provides a balanced output (57), which can then (optionally) be amplified by an amplifier (58) to provide an amplified signal (59), D_{0,0}(t). The PDPE (5) has a fan-out (20), with each stage simultaneously providing a respective output, D_{0,0}(t), D_{0,2}(t), D_{0,3}(t), which forms the output (6) for the PDPE (5) and the Photonic Assembly (100).

It is further noted that, in another embodiment, an amplifier (58) need not be provided in the Tensor Assembly (100) of FIG. 3(b). Accordingly, the balanced output (57) becomes the output, as shown by Case c of FIG. 4. In yet another embodiment, the backend (4) of FIG. 3(b) can be configured according to Case e of FIG. 4. That is, instead of having a balanced detector with first and second photodetectors (45, 47), a coherent summation in the optical domain is realized. Phase shifters such as phase modulators (51, 53) can be used to ensure coherence of both signal output (42, 43). Accordingly, a first phase modulator (51) can receive the input signal (43) A′×B′ from the bus, and a second phase modulator (53) can receive the dot product signal (42). The phase shifter (51), (53) adjust each signal to be phase-aligned so that the dot product (42) is summed by a coherently (55) with the A′×B′ to provide a summed output (56) for output (6).

See the table below Table 2 for some performance gains for the optical input case. The optical output case for coherent summation has no RC-delay, but requires phase stabilization.

The passive filtering has more control on the inter-channel crosstalk and potentially extends the number of wavelengths in a Dense WDM (DWDM) scheme without being affected by the induced quality factor variation caused by the variation of absorption coefficient. The PTC (the D's) can be increased by a factor of N, though N more wavelengths are needed. Since, the spectral filters are used passively only.

The different wavelengths are weighted in a seemingly quantized electro-absorption scheme (i.e. amplitude modulation), thus performing element-wise multiplication. The element-wise multiplications are thence incoherently summed (Cases a-d) up using a photodetector (44) or balanced photodetectors (45, 47), followed eventually by an amplification stage (46, 58), such as a trans-impedance amplifier as illustrated in FIG. 3(b), which amounts to a MAC operation (Dᵢⱼ) (6).

FIG. 5 shows a photonic tensor core (50), which is an N×N array of the Tensor Assembly (100) (e.g., FIG. 2(a), 2(b)). Each of the PDPEs have electrical outputs (except for the option Case e which is an optical summation). There are 2 options for interconnecting each PDPE: either they are connected in read-out columns (electrical), or each PDPE is read out by itself. The latter has more overhead but is much faster from a circuit speed perspective. The core (50) has N² fundamental units, namely dot-product engines (5), which perform an element-wise multiplication whilst featuring a Wavelength Division Multiplexing (WDM) scheme for parallelizing the operation.

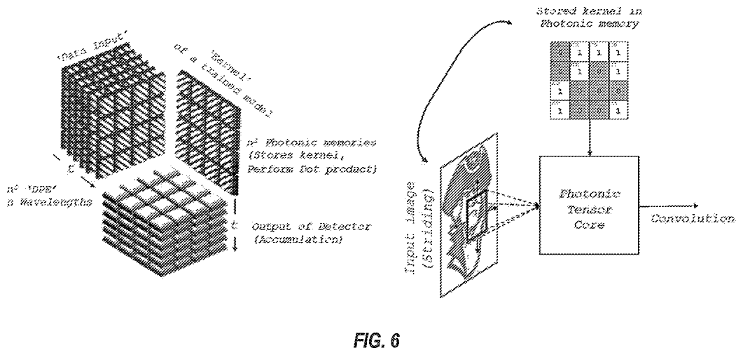

The optical engine (5) unit system can perform matrix-matrix, matrix-vector, or vector-matrix multiplications optically using integrated photonics, optical free-space, or a combination thereof, herein termed Photonic Tensor Core (PTC). Turning to FIG. 6, it can also perform convolutions, and therefore can be used for accelerating different kind of neural networks (e.g. feed-forward neural network, Convolutional neural network (CNN)).

The invention has a wide variety of application, from (high-to-tech) to Optical Artificial intelligence Hardware; Photonic Machine Learning; Photonic Tensor Core. Being vector matrix, dot product and matrix-matrix multiplication fundamental operations for Neural Network, using a photonic accelerator, i.e. PTC which can perform such operations, speeds up the intelligent decisions of NN, while also saving energy.

The architecture has a plurality (e.g. array) of PTC sub-modules (5) that make up a photonic tensor cores (50) that enable real-time intelligent computing at the edge of ultra-high-speed mobile networks (5G and beyond) and internet-connected devices, with throughputs of the order of Peta-operations-per second in 10's of picosecond-short delays, which is 2 orders of magnitude faster and more efficient than currently electronic architectures. The product includes a photonic chip, which integrates reprogrammable multi-state low losses photonic memory, able to perform dot-products and vector matrix multiplications, operations at the heart of machine learning algorithm, completely parallelly and inherently with time complexity of O(1). Time delay after programming the cores (for already trained NN) is given by the time-of-flight of the photon in the chip which is few tens ps. The core can be easily programmed using multistate photonic memories, thus not requiring additional Digital to Analog Converters (DAC).

There are currently two major bottlenecks in the energy efficiency of artificial intelligence (AI) accelerators: data movement, and the performance of MAC operations, or tensor operations. Light is an established communication medium and has traditionally been used to address data movement on a larger scale. As photonic links are scaled to shorter distances and some of their practical problems have been addressed, photonic devices have the potential to deliver both of these bottlenecks on-chip simultaneously. Such photonic systems have been proposed in various configurations to accelerate NN operations. However, their main advantage comes from addressing MAC operations directly. The claimed PTC unit enables seamless system control, effective integration, while delivering high computational performance and competitive cost due to the integrated photonics platform.

Hardware for Machine Intelligence: Most NNs unravel multiple layers of interconnected neurons/nodes. Each neuron and layer, as well as the network interconnectivity, is essential to perform the task which the network has been trained for. In their connected layer, NNs strongly rely on vector matrix math operations, in which large matrices of input data and weights are multiplied, according to the training. Complex multi-layered deep NNs, in fact, require a sizeable amount of bandwidth and low latency for satisfying the vast operation required for performing large matrix multiplication without sacrificing efficiency and speed. Since the dawn of the computing era, due to the ubiquity of matrix math, which extends to neuromorphic computing, researchers have been investigating optimized ways to efficiently multiply matrices. A NN requires convolutional layers (CONV) and fully-connected layers (FC) to perform classification tasks. Thus, the PTC by means of doing VMMs (via MACs) performs the CONV layer of a NN.

Rationale for Photonic in Intelligent Information Processing: Smaller matrix multiplication for less complex inference tasks are still challenged by a non-negligible latency predominantly due to the access overhead of the various memory hierarchies and the latency in executing each instruction in the GPU. Within this paradigm shift the ‘wave’ nature of light and related inherent operations, such as interference and diffraction, can play a major role in enhancing computational throughput and concurrently reducing the power consumption of neuromorphic platforms; in recent years, the revolutionizing impact of NNs contributed to the development of a plethora of emerging technologies, ranging from free-space diffractive optics to nanophotonic processors aiming to improve the computational efficiency of specific tasks performed by NN.

Integrated photonic platforms can provide parallel, power-efficient and low-latency computing, which is possible because analog wave chips can a) perform the dot-product inherently such as via a phase shifters or amplitude modulating components, b) enable signal accumulation (summation) by either electromagnetic coherent interference or incoherent accumulation through photodetectors, and c) enable parallelism strategies and higher throughput using a variety of MUX schemes (e.g. wavelength, polarization, frequency, orbital-angular-momentum). These MUX-options are, at first order, ‘orthogonal’ to each other, thus allowed for a 2^{nd}-order MUX of simultaneous use. Additionally, assisted by state-of-the-art theoretical frameworks, future technologies should perform computing tasks in the domain in which their time varying input signals lay, thus exploiting and leveraging their intrinsic physical operations. In this view, photons are an ideal match for computing node-distributed networks and engines performing intelligent tasks over large data at the edge of a network (e.g. 5G, MIMO, data-center, astronomic telescope arrays, particle-accelerator sensory networks, etc), where the data signals may exist already in the form of photons (e.g. surveillance camera, optical sensor, etc), thus pre-processing/-filtering information for early feature extraction, and/or intelligently regulating the amount of data traffic that is allowed to proceed downstream towards in-depth compute and decision-making systems such as to data-centers, cloud systems, operator headquarters.

However, the functionality of memory for storing the trained weights is not straightforwardly achieved in optics or at least in its non-volatile implementation, and therefore usually requires additional circuitry and components (i.e. DAC, memory) and related consumption of static power, sinking the overall benefits (energy efficiency and speed) of photonics. Therefore, computing AI-systems and machine-learning (ML) tasks, while transferring and storing data exclusively in the optical domain, is highly desirable because of the inherently large bandwidth, low residual crosstalk, and short-delay of optical information transfer.

The invention can also be used for a variety of Use-Cases/Applications ranging from 5G networks, scientific data processing, data centers, data security. Note, VMM-based processing is performing machine-learning tasks, and hence can be used in an ubiquitous across the board and a plethora of applications.

The present invention is significantly faster (1-2 orders of magnitude) and 1 order of magnitude more efficient when performing matrix multiplication with 8-bit precision with respect to current electronic application based on tensor computing.

An illustrative initial performance analysis of a PTC for a selected physical options is as follows: considering a photonic foundry Ge-photodetectors, microring resonator (radius=10 μm) and AIM-photonics disc-modulators, the latency of an individual photonic tensor sub-unit (e.g. unit D_{2,1}) requires Σ{E2O+TOF+Rx+readout}=˜65 ps for processing a 4×4 matrix multiplication resulting in computing 64 MACs at 4 bit precision. This delivers a total 0.5-2 POPS/s throughput for ˜250 4×4 PTC units when limiting the maximum die-area to 800 mm² (assumed: 4-bit DACs area=0.05 mm²) limited mainly by the E2O (i.e. DACs). For an optical data input (e.g. camera), the peak throughput increases to 16 POPS/s for only a few watts of power. If pipelining could be used, the 65 ps drops to ˜20 ps latency, thus improving throughputs by 3×. Hence one could consider sharing DAC usage amongst cores. (Table 2).

TABLE 2

| | | |
|---|---|---|
| Electronic | Optical | |
| Data | Data | NVIDIA |
| PTC | PTC** | T4*** |

| | | |
|---|---|---|
| # of Tensor Cores | 250 | 320 |

| Clock Speed | 50 GHz | N.A. | <1.5 GHz |
|---|---|---|---|
| Bit resolution | 4-bit | | |
| Throughput (POPS/s) | 0.5 (~2)* | ~16 | 0.26 |
| Power | 81 W | <2 W | 70 W |

Table 2 is a Tensor Core performance comparison. Electronic data-fed Photonic Tensor Core (PTC) offers 2-10× throughput improvement over NVIDIA's T4, and for optical data (e.g. camera) improvements are ˜100× (chip area limited to a single die ˜800 mm²). *10:1 DAC reuse. **Optical Data input (no DACs). ***Inference only. In Table 2, column 2 is case 2, column 3 is case 1, and column 4 is prior art in electronics.

The foregoing description and drawings should be considered as illustrative only of the principles of the invention. The invention may be configured in a variety of manners and is not intended to be limited by the embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A system comprising: an engine receiving an input and/or inputs and configured to conduct optical and/or electro-optical tensor operations of the input(s).

2. The system of claim 1, further comprising a first input and a second input, the first and second input are either electronic and/or optical, wherein said engine is configured to conduct the optical tensor operations of the optical input and/or the electronic input.

3. The system of claim 1, wherein said system is a photonic tensor core (PTC) processor comprising of modular PTC sub-modules, which perform multiply-accumulate (MAC) operations.

4. The system of claim 1, further comprising of a plurality of PTC sub-modules.

5. The system of claim 1, wherein the tensor operation comprises one or any combination of the following operations: Matrix-Matrix Multiplication, Matrix-Vector Multiplication, Scalar Product, Pointwise multiplication between matrices, 1-Dimensional Convolution, (Decompose as Matrix-vector Multiplication), 2-Dimensional Convolution, Product for a scalar, or any other possible tensor operation.

6. The system of claim 1, where said PTC sub-module(s) are based on integrated photonics, and/or fiber optics, and/or optical free-space that optically multiplies a first input and a second input and sums an output.

7. The system of claim 6, the optical multiplication and summing comprises a MAC operation.

8. The system of claim 3, said PTC sub-module(s) having an output that is either an electrical signal output or an optical signal output, and further comprising a combination of photodetectors, amplifiers, and/or only waveguides and/or fibers and/or free-space optical components.

9. The system of claim 1, wherein said optical and/or electro-optical tensor operations comprise dot-product operations.

10. The system of claim 9, wherein the dot-product operations are performed electro-optically, thermo-optically, and/or all-optically.

11. The system of claim 3, wherein the accumulation of the MAC operation is performed either by incoherent summation (e.g. photodetector) or coherently (e.g. y-combiners).

12. The system of claim 1, wherein said input(s) are either analog or digital include or omit analog converters (DAC) and/or analog-to-digital converters (ADC), or any combination thereof.

13. The system of claim 1, said engine comprising a multiplexer receiving the input and combining the input onto either a single bus or plurality of busses, a spectral filter dropping a wavelength signal, a multiplier for dot multiplication of the input, and a signal output summation to complete the MAC operation.

14. The system of claim 1, said engine comprising a MAC operation engine to conduct optical and/or electro-optical tensor operations of the input without multiplexing or demultiplexing the input.

15. The system of claim 1, further comprising a plurality of said PTC sub-modules and electrical control lines coupling each of said plurality of photonic dot product engines as part of an electrical control circuitry, or each of said plurality of photonic dot product engines can be separately addressed.
